(19) United States
(12) Patent Application Publication
(10) Pub. No.: US 2025/0273987 A1
(43) Pub. Date: Aug. 28, 2025

(54) METHOD FOR CONTROLLING SUBSTATION MONITORING TERMINAL AND APPARATUS FOR CONTROLLING SUBSTATION MONITORING TERMINAL

(71) Applicant: Zhongshan Power Supply Bureau of Guangdong Power Grid Co Ltd., Zhongshan City (CN)

(72) Inventors: Xiangfeng ZHOU, Zhongshan City (CN); Chunyuan CAI, Zhongshan City (CN); Yongjian LI, Zhongshan City (CN); Huibin ZHOU, Zhongshan City (CN); Hua LI, Zhongshan City (CN); Zhenjiang CHEN, Zhongshan City (CN); Ying ZHANG, Zhongshan City (CN); Lifei LI, Zhongshan City (CN); Weixia JIAN, Zhongshan City (CN); Yanhe YIN, Zhongshan City (CN); Lei LIU, Zhongshan City (CN)

(73) Assignee: Zhongshan Power Supply Bureau of Guangdong Power Grid Co Ltd., Zhongshan City (CN)

(21) Appl. No.: 18/816,887

(22) Filed: Aug. 27, 2024

(30) Foreign Application Priority Data
Feb. 22, 2024 (CN) 202410196576.3

(51) Int. Cl. H02J 13/00

(52) U.S. Cl. CPC H02J 13/00002

(57) ABSTRACT

A method for controlling a substation monitoring terminal and an apparatus for controlling the substation monitoring terminal are provided. According to the method, sent data of the substation monitoring terminal is acquired; a fuzzy inference method is adopted to process the sent data within a pre-determined time period to obtain multiple trapezoid fuzzy sets; it is determined whether the substation monitoring terminal has a security risk according to the multiple trapezoid fuzzy sets; in response to in the substation monitoring terminal having the security risk, the traffic of the substation monitoring terminal to access the Internet of Things is controlled to be reduced.

### CROSS-REFERENCE TO RELATED APPLICATIONS

The present disclosure claims priority to Chinese Patent Application No. 202410196576.3, filed with China Patent Office on Feb. 22, 2024 and entitled “Method for Controlling Substation Monitoring Terminal and Apparatus for Controlling Substation Monitoring Terminal”, the entire disclosure of which is incorporated herein by reference.

### TECHNICAL FIELD

The present disclosure relates to the technical field of power systems and automation thereof, and in particular to a method for controlling a substation monitoring terminal and an apparatus for controlling the substation monitoring terminal, a non-transitory storage medium and an electronic apparatus.

### BACKGROUND

Currently, there are many researches on the data security access control and trust mechanism. However, data security access control mechanism based on the trust mechanism in combination with Attribute-Based Access Control (ABAC) policy idea is not accurate for evaluating the security risk of a substation monitoring terminal.

Therefore, the technical solution to solve the problem of inaccurate security risk evaluation of the substation monitoring terminal has not been provided yet.

### SUMMARY

At least some embodiments of the present disclosure provide a method for controlling a substation monitoring terminal and an apparatus for controlling the substation monitoring terminal, a non-transitory storage medium and an electronic apparatus, so as at least to solve the problem in the related art of inaccurate security risk evaluation of the substation monitoring terminal.

In some embodiments of the present disclosure, a method for controlling a substation monitoring terminal is provided including that: sent data of the substation monitoring terminal is acquired, where the sent data is data sent from the substation monitoring terminal to the Internet of Things, and the data at least includes electricity consumption data of an electricity consumption device monitored by the substation monitoring terminal; a fuzzy inference method is adopted to process the sent data within a pre-determined time period to obtain multiple trapezoid fuzzy sets, where the multiple trapezoid fuzzy sets are used for representing uncertainty of data quality parameters of the substation monitoring terminal, the multiple trapezoid fuzzy sets are obtained by sequencing according to the magnitude of the data quality parameters, the data quality parameters at least comprise: attack counts, error rates, repetition rates, miss rates and channel blocking rates; it is determined whether the substation monitoring terminal has a security risk according to the multiple trapezoid fuzzy sets; in response to in the substation monitoring terminal having the security risk, the traffic of the substation monitoring terminal to access the Internet of Things is controlled to be reduced.

Optionally, the multiple trapezoid fuzzy sets include: attack counts fuzzy sets, error rate fuzzy sets, repetition rate fuzzy sets, miss rate fuzzy sets and channel blocking rate fuzzy sets, where the attack counts fuzzy sets are trapezoid fuzzy sets corresponding to the attack counts, the error rate fuzzy sets are trapezoid fuzzy sets corresponding to the error rates, the repetition rate fuzzy sets are trapezoid fuzzy sets corresponding to the repetition rates, the miss rate fuzzy sets are trapezoid fuzzy sets corresponding to the miss rates, the channel blocking rate fuzzy sets are trapezoid fuzzy sets corresponding to the channel blocking rates, and an operation of adopting the fuzzy inference method to process the sent data within the pre-determined time period to obtain the multiple trapezoid fuzzy sets includes that:
according to a formula N_{ADi}=(N_{ADi1}, N_{ADi2}, N_{ADi3}, N_{ADi4}; k_{ADi}), an i^{th} attack counts fuzzy set N_{ADi} is calculated, where N_{ADi1} is a first fuzzy coefficient of the i^{th} attack counts fuzzy set, N_{ADi2} is a second fuzzy coefficient of the i^{th} attack counts fuzzy set, N_{ADi3} is a third fuzzy coefficient of the i^{th} attack counts fuzzy set, N_{ADi4} is a fourth fuzzy coefficient of the i^{th} attack counts fuzzy set, and k_{DAi} is a membership coefficient of the i^{th} attack counts fuzzy set;
according to a formula kₑᵢ=(kₑᵢ₁, kₑᵢ₂, kₑᵢ₃, kₑᵢ₄; k_{cki}), an i^{th} error rate fuzzy set kₑᵢ is calculated, where kₑᵢ₁ is a first fuzzy coefficient of the i^{th} error rate fuzzy set, kₑᵢ₂ is a second fuzzy coefficient of the i^{th} error rate fuzzy set, kₑᵢ₃ is a third fuzzy coefficient of the i^{th} error rate fuzzy set, kₑᵢ₄ is a fourth fuzzy coefficient of the i^{th} error rate fuzzy set, and kₑₖᵢ is a membership coefficient of the i^{th} error rate fuzzy set;
according to a formula k_{Ri}=(k_{Ri1}, k_{Ri2}, k_{Ri3}, k_{Ri4}; k_{Rki}), an i^{th} repetition rate fuzzy set k_{Ri} is calculated, where A is a first fuzzy coefficient of the i^{th} repetition rate fuzzy set, k_{Ri2} is a second fuzzy coefficient of the i^{th} repetition rate fuzzy set, k_{Ri3} is a third fuzzy coefficient of the i^{th} repetition rate fuzzy set, k_{Ri4} is a fourth fuzzy coefficient of the i^{th} repetition rate fuzzy set, k_{Rki} is a membership coefficient of the i^{th} repetition rate fuzzy set;
according to a formula k_{Li}=(k_{Li1}, k_{Li2}, k_{Li3}, k_{Li4}; k_{Lki}), an i^{th} miss rate fuzzy set k_{Li} is calculated, where k_{Li1} is a first fuzzy coefficient of the i^{th} miss rate fuzzy set, k_{Li2} is a second fuzzy coefficient of the i^{th} miss rate fuzzy set, k_{Li3} is a third fuzzy coefficient of the i^{th} miss rate fuzzy set, k_{Li4} is a fourth fuzzy coefficient of the i^{th} miss rate fuzzy set, k_{Lki} is a membership coefficient of the i^{th} miss rate fuzzy set;
according to a formula k_{Zi}=(k_{Zi1}, k_{Zi2}, k_{Zi3}, k_{Zi4}; k_{Zki}), the i^{th} channel blocking rate fuzzy set k_{Zi} is calculated, where k_{Zi1} is a first fuzzy coefficient of the i^{th} channel blocking rate fuzzy set, k_{Zi2} is a second fuzzy coefficient of the i^{th} channel blocking rate fuzzy set, k_{Zi3} is a third fuzzy coefficient of the i^{th} channel blocking rate fuzzy set, k_{Zi4} is a fourth fuzzy coefficient of the i^{th} channel blocking rate fuzzy set, and k_{Zki} is a membership coefficient of the i^{th} channel blocking rate fuzzy set.

Optionally, an operation of determining whether the substation monitoring terminal has the security risk according to the multiple trapezoid fuzzy sets includes:
a falsity degree of the substation monitoring terminal and a security degree of the substation monitoring terminal is calculated according to the multiple trapezoid fuzzy sets, where the falsity degree is used for representing a falsity extent of the sent data, and the security degree is used for representing a security extent of the sent data;
in response to the falsity degree being greater than a first threshold value, it is determined that the substation monitoring terminal has a security risk of falsity data;
in response to the security degree being greater than a second threshold value, it is determined that the substation monitoring terminal has a security risk of a data attack.

Optionally, an operation of calculating the falsity degree of the substation monitoring terminal according to the multiple trapezoid fuzzy sets includes that:
according to a formula:

$${N}_{FD} = {N}_{D} {\sum }_{t = 1}^{{N}_{RP}} ( {k}_{eC}^{t} {k}_{eL}^{t} {\sum }_{i = 1}^{x} E [ {k}_{ie} ] + {k}_{RC}^{t} {k}_{RL}^{t} {\sum }_{i = 1}^{x} E [ {k}_{Ri} ] + {k}_{LC}^{t} {k}_{LL}^{t} {\sum }_{i = 1}^{x} E [ {k}_{Li} ] ) ,$$

a falsity data amount N_{FD} is calculated, where N_{D} is a data amount of the sent data, t=1, 2, . . . , N_{RP}, k′_{eC} is a weight coefficient of data loss caused by data errors, k′_{eL} is a unit data loss value caused by the data errors, kₑᵢ is the trapezoid fuzzy set corresponding to the error rates, k′_{RC} is a weight coefficient of data loss caused by data repetition, k′_{RL} is a unit data loss value caused by the data repetition, k_{Ri} is the trapezoid fuzzy set corresponding to the repetition rates, k′_{LC} is a weight coefficient for data loss due to data missing, k′_{LL} is a unit data loss value caused by the data missing, k_{Li} is a trapezoid fuzzy set corresponding to the miss rates;
a real data amount of the sent data is acquired, and the falsity degree k_{F} is calculated according to a formula

$${k}_{F} = \frac{{N}_{FD}}{{N}_{TD} + {N}_{FD}} ,$$

where N_{TD} is the real data amount of the sent data.

Optionally, an operation of calculating the security degree of the substation monitoring terminal according to the multiple trapezoid fuzzy sets includes that:
a real data amount of the sent data and a security data amount of the sent data are acquired, and the security degree k_{A} is calculated according to a formula

$${k}_{A} = \frac{{N}_{AD}}{{N}_{TD} + {N}_{AD}} ,$$

where N_{AD} is the security data amount of the sent data, and N_{TD} is the real data amount of the sent data.

Optionally, an operation of determining whether the substation monitoring terminal has the security risk according to the multiple trapezoid fuzzy sets includes that:
a trust degree of the substation monitoring terminal is calculated according to the multiple trapezoid fuzzy sets, where the trust degree is used for representing the risk extent of the substation monitoring terminal to access the Internet of Things; and in response to the trust degree being less than a third threshold value, it is determined that there is a security risk for the substation monitoring terminal accesses the Internet of Things.

Optionally, an operation of calculating the trust degree of the substation monitoring terminal according to the trapezoid fuzzy sets includes that:
according to a formula

$${R}_{RP} = \frac{{n}_{G}}{{n}_{IoT}} \times E [ {{∨}^{x}}_{i = 1} {k}_{Di} {v}_{Dvi} ⊗ {{∨}^{x}}_{i = 1} {k}_{DSi} {S}_{Di} ⊗ {k}_{Mi} {M}_{G} ] ,$$

a data gain value R_{RP} of the substation monitoring terminal is calculated, where the data gain value is used for representing a data gain obtained by the substation monitoring terminal through data acquisition, data transmission, data storage and data sharing, n_{G} is the number of users using the substation monitoring terminal to access the Internet of Things, N_{IoT} is the number of users of the Internet of Things,

$$\begin{matrix}{L}_{D} = {\sum }_{t = 1}^{{N}_{RP}} ( {k}_{AC}^{t} {k}_{AL}^{t} {\sum }_{i = 1}^{x} E [ {N}_{ADi} ] + {k}_{eC}^{t} {k}_{eL}^{t} {\sum }_{i = 1}^{x} E [ {k}_{ei} ] ) \\ + {\sum }_{t = 1}^{{N}_{RP}} ( {k}_{RC}^{t} {k}_{RL}^{t} {\sum }_{i = 1}^{x} E [ {N}_{Ri} ] + {k}_{LC}^{t} {k}_{LL}^{t} {\sum }_{i = 1}^{x} E [ {k}_{Li} ] ) \\ + {\sum }_{t = 1}^{{N}_{RP}} ( {k}_{ZC}^{t} {k}_{ZL}^{t} {\sum }_{i = 1}^{x} E [ {k}_{Zi} ] )\end{matrix} ,$$

is an information gain value obtained by providing the data transmission with x_{fuzzy} uncertainty rates to the substation monitoring terminal,

$${{∨}^{x}}_{i = 1} {k}_{Di} {v}_{Dvi}$$

is an information gain value obtained by providing the data storage and the data sharing with x fuzzy uncertainty scales to the substation monitoring terminal, k_{Mi}M_{G} is an information gain value obtained through providing, by the Internet of Things at a sensing layer, the collecting data to the substation monitoring terminal;
according to a formula

$${{∨}^{x}}_{i = 1} {k}_{DSi} {S}_{Di}$$

a data loss value L_{D} of the substation monitoring terminal is calculated, where the data loss value is used for representing data loss caused by data attack, data error, data repetition, data missing and channel blocking, t=1, 2, . . . , N_{RP}, k′_{AC} is a weight coefficient of the data loss caused by the data attack, k′_{AL} is a unit data loss value caused by the data attack, N_{ADi} is a trapezoid fuzzy set corresponding to the attack counts, k′_{eC} is a weight coefficient of data loss caused by the data error, k′_{eL} is a unit data loss value caused by the data error, kₑᵢ is a trapezoid fuzzy set corresponding to the error rate, and k′_{RC} is a weight coefficient of data loss caused by the data repetition, k′_{RL} is a unit data loss value caused by the data repetition, k_{Ri} is a trapezoid fuzzy set corresponding to the repetition rates, k′_{LC} is a weight coefficient for data loss due to the data missing, k′_{LL} is a unit data loss value caused by the data missing, k′_{Zi} is a trapezoid fuzzy set corresponding to the miss rates, k′_{ZC} is a weight coefficient of data loss caused by the channel blocking, k′_{ZL} is a unit data loss value caused by the channel blocking, k_{Zi} is a trapezoid fuzzy set corresponding to the channel blocking rates; the trust degree B₁ is calculated according to a formula

$${B}_{1} = \frac{{R}_{RP}}{{R}_{RP} + {L}_{D}} .$$

In some embodiments of the present disclosure, an apparatus for controlling the substation monitoring terminal is provided, including: an acquisition unit arranged for acquiring sent data of the substation monitoring terminal, where the sent data is data sent from the substation monitoring terminal to the Internet of Things, and the data at least includes electricity consumption data of an electricity consumption device monitored by the substation monitoring terminal; a processing unit arranged for adopting a fuzzy inference method to process the sent data within a pre-determined time period to obtain multiple trapezoid fuzzy sets, where the multiple trapezoid fuzzy sets are used for representing uncertainty of data quality parameters of the substation monitoring terminal, the multiple trapezoid fuzzy sets are obtained by sequencing according to the magnitude of the data quality parameters, the data quality parameters at least include: attack counts, error rates, repetition rates, miss rates and channel blocking rates; a determination unit arranged for determining whether the substation monitoring terminal has a security risk according to the multiple trapezoid fuzzy sets; a control unit arranged for, in response to in the substation monitoring terminal having the security risk, controlling the traffic of the substation monitoring terminal to access the Internet of Things to be reduced.

In some embodiments of the present disclosure, a non-transitory storage medium is further provided. The non-transitory storage medium includes a program. When the program runs, the non-transitory storage medium is controlled to execute any one of the methods described above.

In some embodiments of the present disclosure, an electronic apparatus is further provided, including a memory and a processor, where the memory is arranged for storing a computer program, and the processor is arranged for executing any one of the methods according to the computer program.

Through applying the technical solution of the present disclosure, sent data of the substation monitoring terminal is acquired; a fuzzy inference method is adopted to process the sent data within a pre-determined time period to obtain multiple trapezoid fuzzy sets; it is determined whether the substation monitoring terminal has a security risk according to the multiple trapezoid fuzzy sets; in response to in the substation monitoring terminal having the security risk, the traffic of the substation monitoring terminal to access the Internet of Things is controlled to be reduced. In this method, a data error formed by attacks, errors, repetition, missing and channel blocking when the substation monitoring terminal sends data to the Internet of Things in combination with the fuzzy inference method, the trapezoid fuzzy sets can be calculated, so that a technical benefit evaluation index of the sent data sent from the substation monitoring terminal to the Internet of Things can be constructed to determine whether a substation monitoring terminal has a security risk; and in response to the substation monitoring terminal having the security risk, the traffic of the substation monitoring terminal to access the Internet of Things can be controlled to be reduced, thereby solving the problem of inaccurate security risk evaluation of the substation monitoring terminal.

### BRIEF DESCRIPTION OF THE DRAWINGS

The accompanying drawings, which form a part of the present disclosure, are used for providing a further understanding of the present disclosure. The schematic embodiments and illustrations of the present disclosure are used for explaining the present disclosure, and do not form improper limits to the present disclosure. In the drawings:

FIG. 1 is a block diagram of a hardware structure of a mobile terminal for executing a method for controlling a substation monitoring terminal according to some embodiments of the present disclosure;

FIG. 2 is a schematic flowchart of a method for controlling a substation monitoring terminal according to some embodiments of the present disclosure;

FIG. 3 is a structural block diagram of an apparatus for controlling a substation monitoring terminal according to some embodiments of the present disclosure.

The above drawings include the following reference signs:

102, a processor; 104, a memory; 106, a transmission device; 108, an input/output device.

### DETAILED DESCRIPTION

It should be noted that, in the case of no conflict, the embodiments of the present disclosure and the features of the embodiments can be combined with each other. The present disclosure will be described in detail below with reference to the accompanying drawings and in combination with the embodiments.

In order to enable those skilled in the art to better understand the technical solution of the present disclosure, the technical solution in the embodiments of the present disclosure will be clearly and completely described below with reference to the accompanying drawings in the embodiments of the present disclosure. All other embodiments obtained by those skilled in the art based on the embodiments of present disclosure without creative efforts shall fall within the protection scope of present disclosure.

It should be noted that the terms “first”, “second”, and the like in the specification, claims, and accompanying drawings of present disclosure are used for distinguishing similar objects, and are not necessarily used for describing a specific order or sequence. It should be understood that the data used in this way can be interchanged under appropriate circumstances so as to facilitate the embodiments of the present disclosure described herein. In addition, the terms “include” and “have” and any deformation thereof are intended to cover a non-exclusive inclusion, for example, a process, method, system, product, or device that includes a series of steps or units is not necessarily limited to those steps or units listed clearly, but can include other steps or units that are not clearly listed or inherent to these processes, methods, products, or devices.

As introduced in the background, in the related art, the technical solution to solve the problem of inaccurate security risk evaluation of the substation monitoring terminal has not been provided yet. In order to solve the problem, some embodiments of the present disclosure provide a method for controlling a substation monitoring terminal and an apparatus for controlling the substation monitoring terminal, a non-transitory storage medium and an electronic apparatus.

The technical solutions in the embodiments of the present disclosure will be clearly and completely described below with reference to the accompanying drawings in the embodiments of the present disclosure.

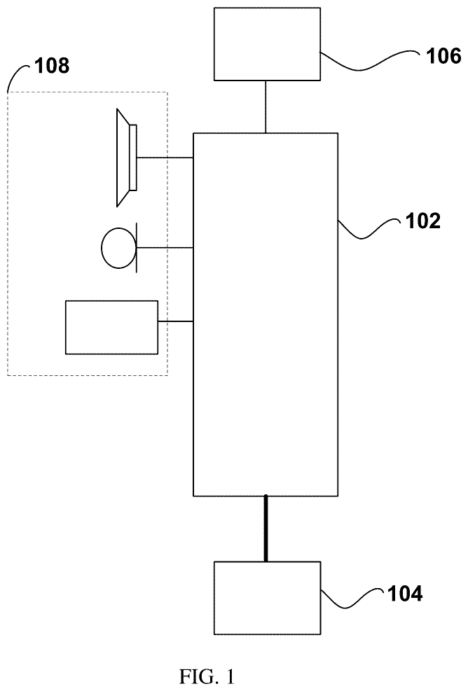

The method embodiments provided in the embodiments of present disclosure can be performed in a mobile terminal, a computer terminal, or a similar computing apparatus. Taking the mobile terminal as an example, FIG. 1 is a block diagram of a hardware structure of a mobile terminal of a method for controlling a substation monitoring terminal according to some embodiments of the present invention. As shown in FIG. 1, the mobile terminal includes at least one processor 102 (one of the at least one processor is shown in FIG. 1, and the at least one processor 102 includes, but is not limited to, a processing apparatus such as a Microcontroller Unit (MCU) or a Field-Programmable Gate Array (FPGA)) and a memory 104 for storing data, where the mobile terminal further includes a transmission device 106 with a communication function and an input/output device 108. Those skilled in the art can understand that the structure shown in FIG. 1 is an example, and does not limit the structure of the mobile terminal. For example, the mobile terminal can further include more or fewer components than those shown in FIG. 1, or have a configuration different from that shown in FIG. 1.

The memory 104 is arranged for storing a computer program, for example, a software program and a module of application software, for example, a computer program corresponding to a method for controlling a substation monitoring terminal in the embodiments of the present disclosure, and the processor 102 executes various functional applications and data processing through running the computer program stored in the memory 104, that is, implements the method. The memory 104 includes a high-speed random access memory, and further includes a non-transitory memory, such as at least one magnetic storage apparatus, flash memory, or other non-transitory solid-state memory. In some examples, the memory 104 further includes a memory remotely arranged relative to the processor 102, and this remote memory can be connected with the mobile terminal through a network. Examples of the above network include, but are not limited to, an Internet, an intranet, a local area network, a mobile communication network, and combinations thereof. The transmission device 106 is arranged for receiving or sending data via a network. Specific examples of the above-mentioned network include a wireless network provided by a communication provider of the mobile terminal. In one example, the transmission device 106 includes a Network Interface Controller (NIC), which can be connected with other network devices through a base station to communicate with the Internet. In one example, the transmission device 106 is a Radio Frequency (RF) module, which is arranged for communicating with the Internet in a wireless manner.

In the present embodiment, a method for controlling a substation monitoring terminal running on the mobile terminal, the computer terminal or the similar computing apparatus is provided. It should be noted that the steps shown in the flowchart of the accompanying drawings can be set as a group of computer-executable instructions executed in a computer system. And although a logical order is shown in the flowchart, in some cases, the steps shown or described can be performed in an order different from that described herein.

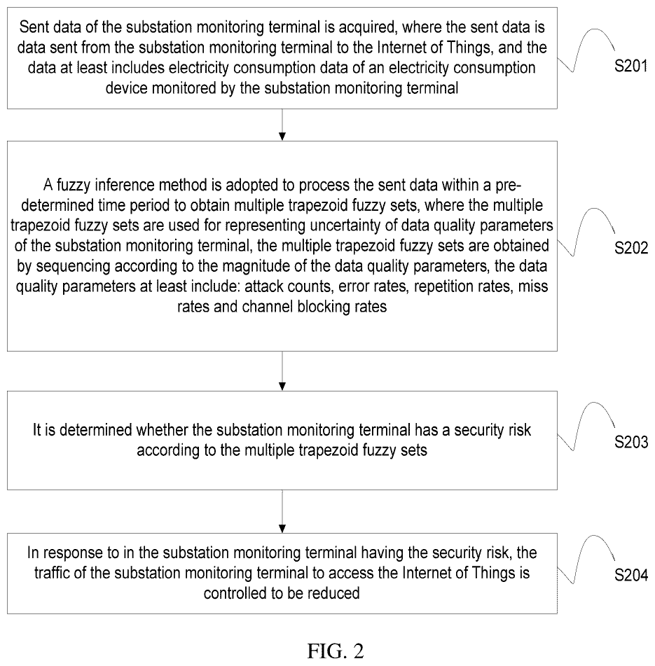

FIG. 2 is a flowchart of a method for controlling a substation monitoring terminal according to some embodiments of the present disclosure. As shown in FIG. 2, the method includes the following steps.

In step S201, sent data of the substation monitoring terminal is acquired, where the sent data is data sent from the substation monitoring terminal to the Internet of Things, and the data at least includes electricity consumption data of an electricity consumption device monitored by the substation monitoring terminal.

Specifically, the sent data includes: a high-low voltage side voltage, a current, a power, a frequency, a temperature, a pressure and a humidity of a transformer; a voltage, a current, a power of a bus bar; a voltage, a current, a power of inlet and outlet; an operating state of a switch; a running state, a voltage, a current and a power of an energy storage system; a running state, a voltage, a current and a power of a charging post; a running state, a voltage, a current and a power of a reactive power compensator.

In step S202, a fuzzy inference method is adopted to process the sent data within a pre-determined time period to obtain multiple trapezoid fuzzy sets, where the multiple trapezoid fuzzy sets are used for representing uncertainty of data quality parameters of the substation monitoring terminal, the multiple trapezoid fuzzy sets are obtained by sequencing according to the magnitude of the data quality parameters, the data quality parameters at least include: attack counts, error rates, repetition rates, miss rates and channel blocking rates.

Specifically, attack counts refer to the counts of malicious attacks on a data system or a network. These attacks include denial-of-service attacks, injection attacks, identity theft, etc. The attack counts are used for evaluating the security and robustness of the data system or the network. The error rates refer to a frequency at which errors occurs during data transmission or processing. Even without any malicious attack, the sent data may be erroneous during the data transmission. The error rates are used for measuring the reliability of the data transmission or processing. The repetition rates refer to a frequency at which repeated data occurs during the data transmission or processing. Occasionally, the same data is retransmitted or processed due to interference in communication, transmission errors, or other reasons. The repetition rates are used for measuring the accuracy of the data transmission or processing. The miss rates refer to a frequency at which data is lost, due to transmission errors, communication disruption, system failure, etc., during the data transmission or processing. The miss rates are used for measuring the integrity of the data transmission or processing. The channel blocking rates refer to a rate at which data cannot be transmitted due to channel blocking during the data transmission. Channel blocking refers to that, in data transmission, data cannot be transmitted through a channel due to insufficient channel capacity or other factors. The channel blocking rates are used for measuring the load and efficiency of the data transmission.

In step S203, it is determined whether the substation monitoring terminal has a security risk according to the multiple trapezoid fuzzy sets.

Specifically, for example, nine fuzzy trapezoid fuzzy sets with uncertainty are determined according to the data quality, containing extremely low, very low, low, low, medium, high, high, very high, and extremely high, of parameters.

In step S204: in response to in the substation monitoring terminal having the security risk, the traffic of the substation monitoring terminal to access the Internet of Things is controlled to be reduced.

In particular, reducing the traffic of the substation monitoring terminal to access the Internet of Things can help the substation detect and prevent potential security threats. In addition, abnormal data interaction patterns, abnormal data amounts or frequencies, etc. can be found through analyzing the traffic, thereby identifying possible attacks or illegal accesses. Early discovering security threats and adopting corresponding security measures can protect the security and integrity of the Internet of Things system.

Through applying the technical solution of the present disclosure, sent data of the substation monitoring terminal is acquired; a fuzzy inference method is adopted to process the sent data within a pre-determined time period to obtain multiple trapezoid fuzzy sets; it is determined whether the substation monitoring terminal has a security risk according to the multiple trapezoid fuzzy sets; in response to in the substation monitoring terminal having the security risk, the traffic of the substation monitoring terminal to access the Internet of Things is controlled to be reduced. In this method, a data error formed by attacks, errors, repetition, missing and channel blocking when the substation monitoring terminal sends data to the Internet of Things in combination with the fuzzy inference method, the trapezoid fuzzy sets can be calculated, so that a technical benefit evaluation index of the sent data sent from the substation monitoring terminal to the Internet of Things can be constructed to determine whether a substation monitoring terminal has a security risk; and in response to the substation monitoring terminal having the security risk, the traffic of the substation monitoring terminal to access the Internet of Things can be controlled to be reduced, thereby solving the problem of inaccurate security risk evaluation of the substation monitoring terminal.

In some implementation processes, the multiple trapezoid fuzzy sets include: attack counts fuzzy sets, error rate fuzzy sets, repetition rate fuzzy sets, miss rate fuzzy sets and channel blocking rate fuzzy sets, where the attack counts fuzzy sets are trapezoid fuzzy sets corresponding to the attack counts, the error rate fuzzy sets are trapezoid fuzzy sets corresponding to the error rates, the repetition rate fuzzy sets are trapezoid fuzzy sets corresponding to the repetition rates, the miss rate fuzzy sets are trapezoid fuzzy sets corresponding to the miss rates, the channel blocking rate fuzzy sets are trapezoid fuzzy sets corresponding to the channel blocking rates. The step S202 is implemented through the following steps.

Instep S2021, according to a formula N_{ADi}=(N_{ADi1}, N_{ADi2}, N_{ADi3}, N_{ADi4}; k_{DAi}), an i^{th} attack counts fuzzy set N_{ADi} is calculated, where N_{ADi1} is a first fuzzy coefficient of the i^{th} attack counts fuzzy set, N_{ADi2} is a second fuzzy coefficient of the i^{th} attack counts fuzzy set, N_{ADi3} is a third fuzzy coefficient of the i^{th} attack counts fuzzy set, N_{ADi4} is a fourth fuzzy coefficient of the i^{th} attack counts fuzzy set, and k_{DAi} a is a membership coefficient of the i^{th} attack counts fuzzy set.

In step S2022, according to a formula kₑᵢ=(kₑᵢ₁, kₑᵢ₂, kₑᵢ₃, kₑᵢ₄; kₑₖᵢ), an i^{th} error rate fuzzy set kₑᵢ is calculated, where kₑᵢ₁ is a first fuzzy coefficient of the i^{th} error rate fuzzy set, kₑᵢ₂ is a second fuzzy coefficient of the i^{th} error rate fuzzy set, kₑᵢ₃ is a third fuzzy coefficient of the i^{th} error rate fuzzy set, kₑᵢ₄ is a fourth fuzzy coefficient of the i^{th} error rate fuzzy set, and kₑₖᵢ is a membership coefficient of the i^{th} error rate fuzzy set.

In step S2023, according to a formula k_{Ri}=(k_{Ri1}, k_{Ri2}, k_{Ri3}, k_{Ri4}; k_{Rki}), an i^{th} repetition rate fuzzy set k_{Ri} is calculated, where k_{Ri1} is a first fuzzy coefficient of the i^{th} repetition rate fuzzy set, k_{Ri2} is a second fuzzy coefficient of the i^{th} repetition rate fuzzy set, k_{Ri3} is a third fuzzy coefficient of the i^{th} repetition rate fuzzy set, R_{Ri4} is a fourth fuzzy coefficient of the i^{th} repetition rate fuzzy set, k_{Rki} is a membership coefficient of the i^{th} repetition rate fuzzy set.

Instep S2024, according to a formula k_{Li}=(k_{Li1}, k_{Li2}, k_{Li3}, k_{Li4}; k_{Lki}), an i^{th} miss rate fuzzy set k_{Li} is calculated, where k_{Li1} is a first fuzzy coefficient of the i^{th} miss rate fuzzy set, k_{Li2} is a second fuzzy coefficient of the i^{th} miss rate fuzzy set, k_{Li3} is a third fuzzy coefficient of the i^{th} miss rate fuzzy set, k_{Li4} is a fourth fuzzy coefficient of the i^{th} miss rate fuzzy set, k_{Lki} is a membership coefficient of the i^{th} miss rate fuzzy set.

In step S2025, according to a formula k_{Zi}=(k_{Zi1}, k_{Zi2}, k_{Zi3}, k_{Zi4}; k_{Zki}, the i^{th} channel blocking rate fuzzy set k_{Zi} is calculated, where k_{Zi1} is a first fuzzy coefficient of the i^{th} channel blocking rate fuzzy set, k_{Zi2} is a second fuzzy coefficient of the i^{th} channel blocking rate fuzzy set, k_{Zi3} is a third fuzzy coefficient of the i^{th} channel blocking rate fuzzy set, k_{Zi4} is a fourth fuzzy coefficient of the i^{th} channel blocking rate fuzzy set, and k_{Zki} is a membership coefficient of the i^{th} channel blocking rate fuzzy set.

Specifically, each trapezoid fuzzy set is a form of common fuzzy set, and each trapezoid fuzzy set is composed of two straight lines with a rising slope and a falling slope, and two adjustable parameters. The trapezoid fuzzy set is used for describing some blurring phenomena, for example, the quality of some articles, the satisfaction degree of some people, and the like. Compared with other fuzzy set forms, the trapezoid fuzzy set has better interpretability and controllability, since the shape of this trapezoid fuzzy set is simple, parameters of this trapezoid fuzzy set are relatively intuitional for understanding and adjusting. In practical applications, the trapezoid fuzzy set is widely used for representing a fuzzy concept and a fuzzy rule, for example, the trapezoid fuzzy set is applied in fields such as a fuzzy control system and a fuzzy classifier.

In order to further rapidly determine whether the substation monitoring terminal has the security risk of data attacks, the step S203 of the present disclosure can be realized by the following steps.

In step S2031, a falsity degree of the substation monitoring terminal and a security degree of the substation monitoring terminal is calculated according to the multiple trapezoid fuzzy sets, where the falsity degree is used for representing a falsity extent of the sent data, and the security degree is used for representing a security extent of the sent data.

In step S2032, in response to the falsity degree being greater than a first threshold value, it is determined that the substation monitoring terminal has a security risk of falsity data.

Instep S2033, in response to the security degree being greater than a second threshold value, it is determined that the substation monitoring terminal has a security risk of a data attack.

Specifically, a value range of the first threshold is 0-0.1. A value range of the second threshold is 0-0.1. The value of the first threshold can be the same as the value of the second threshold, or the value of the first threshold can be different from the value of the second threshold.

The step S2031 can be implemented in other manners, for example, the step S2031 can be realized by the following steps.

In step S20311, according to a formula:

$${N}_{FD} = {N}_{D} {\sum }_{t = 1}^{{N}_{RP}} ( {k}_{eC}^{t} {k}_{eL}^{t} {\sum }_{i = 1}^{x} E [ {k}_{ei} ] + {k}_{RC}^{t} {k}_{RL}^{t} {\sum }_{i = 1}^{x} E [ {k}_{Ri} ] + {k}_{LC}^{t} {k}_{LL}^{t} {\sum }_{i = 1}^{x} E [ {k}_{Li} ] ) ,$$

a falsity data amount N_{FD} is calculated, where N_{D} is a data amount of the sent data, t=1, 2, . . . , N_{RP}, k′_{eC} is a weight coefficient of data loss caused by data errors, k′_{eL} is a unit data loss value caused by the data errors, kₑᵢ is the trapezoid fuzzy set corresponding to the error rates, k′_{RC} is a weight coefficient of data loss caused by data repetition, k′_{RL} is a unit data loss value caused by the data repetition, k_{Ri} is the trapezoid fuzzy set corresponding to the repetition rates, k′_{LC} is a weight coefficient for data loss due to data missing, k′_{LL} is a unit data loss value caused by the data missing, k_{Li} is a trapezoid fuzzy set corresponding to the miss rates.

In step S20312: a real data amount of the sent data is acquired, and the falsity degree k_{F} is calculated according to a formula

$${k}_{F} = \frac{{N}_{FD}}{{N}_{TD} + {N}_{FD}} ,$$

where N_{TD} is the real data amount of the sent data.

In particular, for example, k_{F}=0 represents data security; k_{F}>0, proves that there is falsity data, and the greater the value of k_{F}, the higher the degree of data risk. Data security level 1 warning is issued in response to 0<k_{F}≤0.1. Data security level 2 warning is issued in response to 0.2<k_{F}≤0.3. Data security level 3 warning is issued in response to 0.3<k_{F}≤0.4. Data security level 4 warning is issued in response to 0.4<k_{F}≤0.5. Data security level 5 warning is issued in response to 0.5<k_{F}≤0.6. Data security level 6 warning is issued in response to 0.6<k_{F}≤0.7. Data security level 7 warning is issued in response to 0.7<k_{F}≤0.8. Data security level 8 warning is issued in response to 0.8<k_{F}≤0.9. Data security level 9 warning is issued in response to 0.9<k_{F}≤1.0.

In some embodiments, the step S2031 may be specifically implemented by the following steps.

Instep S20313: a real data amount of the sent data and a security data amount of the sent data are acquired, and the security degree k_{A} is calculated according to a formula

$${k}_{A} = \frac{{N}_{AD}}{{N}_{TD} + {N}_{AD}} ,$$

where N_{AD} is the security data amount of the sent data, and N_{TD} is the real data amount of the sent data. The method can further calculate to obtain an accurate security degree.

In particular, for example, k_{A}=0 represents data security. k_{A}>0 proves that there is a data attack problem, and the larger the value of k_{A}, the higher the degree of data risk. Data security level 1 warning is issued in response to 0<k_{A}≤0.1. Data security level 2 warning is issued in response to 0.2<k_{A}≤0.3. Data security level 3 warning is issued in response to 0.3<k_{A}≤0.4. Data security level 4 warning is issued in response to 0.4<k_{A}≤0.5. Data security level 5 warning is issued in response to 0.5<k_{A}≤0.6. Data security level 6 warning is issued in response to 0.6<k_{A}≤0.7. Data security level 7 warning is issued in response to 0.7<k_{A}≤0.8. Data security level 8 warning is issued in response to 0.8≤k_{A}≤0.9. Data security level 9 warning is issued in response to 0.9<k_{A}≤1.0.

In some embodiments, the step S203 can be implemented in the following manner.

In step S2034, a trust degree of the substation monitoring terminal is calculated according to the multiple trapezoid fuzzy sets, where the trust degree is used for representing the risk extent of the substation monitoring terminal to access the Internet of Things.

In step S2035, in response to the trust degree being less than a third threshold value, it is determined that there is a security risk for the substation monitoring terminal accesses the Internet of Things. The method can further rapidly determine, according to the trust degree, whether the substation monitoring terminal has the security risk to access the Internet of Things.

Specifically, a value range of the third threshold is 0.4-0.6.

In some embodiments, the step S2034 may be implemented in the following manner.

In step S20341, according to a formula:

$${R}_{RP} = \frac{{n}_{G}}{{n}_{IoT}} \times E [ {{∨}^{x}}_{i = 1} {k}_{Di} {v}_{Dvi} ⊗ {{∨}^{x}}_{i = 1} {k}_{DSi} {S}_{Di} ⊗ {k}_{Mi} {M}_{G} ] ,$$

a data gain value R_{RP} of the substation monitoring terminal is calculated, where the data gain value is used for representing a data gain obtained by the substation monitoring terminal through data acquisition, data transmission, data storage and data sharing, n_{G} is the number of users using the substation monitoring terminal to access the Internet of Things, n_{IoT} is the number of users of the Internet of Things,

$${{∨}^{x}}_{i = 1} {k}_{Di} {v}_{Dvi}$$

is an information gain value obtained by providing the data transmission with x fuzzy uncertainty rates to the substation monitoring terminal,

$${{∨}^{x}}_{i = 1} {k}_{DSi} {S}_{Di}$$

is an information gain value obtained by providing the data storage and the data sharing with X fuzzy uncertainty scales to the substation monitoring terminal, k_{Mi}M_{G} is an information gain value obtained through providing, by the Internet of Things at a sensing layer, the collecting data to the substation monitoring terminal.

In step S20342, according to a formula:

$$\begin{matrix}{L}_{D} = {\sum }_{t = 1}^{{N}_{RP}} ( {k}_{AC}^{t} {k}_{AL}^{t} {\sum }_{i = 1}^{x} E [ {N}_{ADi} ] + {k}_{eC}^{t} {k}_{eL}^{t} {\sum }_{i = 1}^{x} E [ {k}_{ei} ] ) \\ + {\sum }_{t = 1}^{{N}_{RP}} ( {k}_{RC}^{t} {k}_{RL}^{t} {\sum }_{i = 1}^{x} E [ {N}_{Ri} ] + {k}_{LC}^{t} {k}_{LL}^{t} {\sum }_{i = 1}^{x} E [ {k}_{Li} ] ) \\ + {\sum }_{t = 1}^{{N}_{RP}} ( {k}_{ZC}^{t} {k}_{ZL}^{t} {\sum }_{i = 1}^{x} E [ {k}_{Zi} ] )\end{matrix} ,$$

a data loss value L_{D} of the substation monitoring terminal is calculated, where the data loss value is used for representing data loss caused by data attack, data error, data repetition, data missing and channel blocking, t=1, 2, . . . , N_{RP}, k′_{AC} is a weight coefficient of the data loss caused by the data attack, k′_{AL} is a unit data loss value caused by the data attack, N_{ADi} is a trapezoid fuzzy set corresponding to the attack counts, k′_{eC} is a weight coefficient of data loss caused by the data error, k′_{eL} is a unit data loss value caused by the data error, kₑᵢ is a trapezoid fuzzy set corresponding to the error rate, and k′_{RC} is a weight coefficient of data loss caused by the data repetition, k′_{RL} is a unit data loss value caused by the data repetition, k_{Ri} is a trapezoid fuzzy set corresponding to the repetition rates, k′_{LC} is a weight coefficient for data loss due to the data missing, k′_{LL} is a unit data loss value caused by the data missing, k_{Li} is a trapezoid fuzzy set corresponding to the miss rates, k′_{ZC} is a weight coefficient of data loss caused by the channel blocking, k′_{ZL} is a unit data loss value caused by the channel blocking, k_{Zi} a is a trapezoid fuzzy set corresponding to the channel blocking rates; the trust degree B₁ is calculated according to a formula

$${B}_{1} = \frac{{R}_{RP}}{{R}_{RP} + {L}_{D}} .$$

The method can further calculate to obtain an accurate trust degree.

Specifically, for example, when 0.5≤B₁<1, the substation monitoring terminal is allowed to access the Internet of Things with full data traffic, and when 0.3≤B₁<0.5, user access traffic is controlled to be B₁ times standard traffic, the user is allowed to access the Internet of Things moderately. When 0≤B₁<0.3, an access traffic of the substation monitoring terminal is restricted to be 0, thereby preventing the user from accessing the Internet of Things, and not allowing the substation monitoring terminal to access the Internet of Things.

In order to enable those skilled in the art to understand the technical solutions of the present disclosure more clearly, the implementation process of the method for controlling the substation monitoring terminal of the present disclosure will be described in detail below in conjunction with specific embodiments.

In some embodiments of the present disclosure, an apparatus for controlling the substation monitoring terminal is provided. It should be noted that, the apparatus for controlling the substation monitoring terminal in some embodiments of the present disclosure can be arranged for performing the information identification-based power Internet of Things protection method in some embodiments of present disclosure. The apparatus is arranged for implementing the embodiments and exemplary implementations, and details are not described again. As used below, the term “module” may implement a combination of software and/or hardware of a predetermined function. Although the apparatus described in the following embodiments is exemplarily implemented in software, implementation of hardware or a combination of software and hardware is also possible and conceived.

The following introduces the apparatus for controlling the substation monitoring terminal provided in some embodiments of the present disclosure.

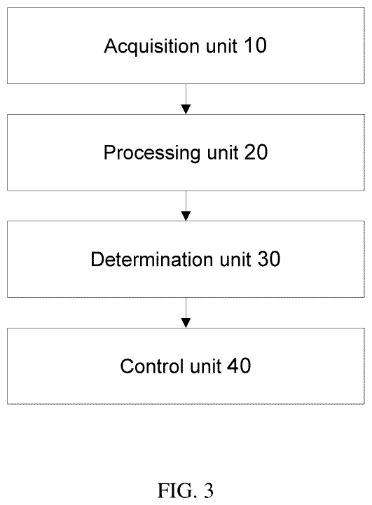

FIG. 3 is a schematic diagram of an apparatus for controlling a substation monitoring terminal according to some embodiments of the present disclosure. As shown in FIG. 3, the apparatus includes: an acquisition unit 10, a processing unit 20, a determination unit 30 and a control unit 40.

The acquisition unit 10 is arranged for acquiring sent data of the substation monitoring terminal, where the sent data is data sent from the substation monitoring terminal to the Internet of Things, and the data at least includes electricity consumption data of an electricity consumption device monitored by the substation monitoring terminal.

Specifically, the sent data includes: a high-low voltage side voltage, a current, a power, a frequency, a temperature, a pressure and a humidity of a transformer; a voltage, a current, a power of a bus bar; a voltage, a current, a power of inlet and outlet; an operating state of a switch; a running state, a voltage, a current and a power of an energy storage system; a running state, a voltage, a current and a power of a charging post; a running state, a voltage, a current and a power of a reactive power compensator.

The processing unit 20 is arranged for adopting a fuzzy inference method to process the sent data within a pre-determined time period to obtain multiple trapezoid fuzzy sets, where the multiple trapezoid fuzzy sets are used for representing uncertainty of data quality parameters of the substation monitoring terminal, the multiple trapezoid fuzzy sets are obtained by sequencing according to the magnitude of the data quality parameters, the data quality parameters at least include: attack counts, error rates, repetition rates, miss rates and channel blocking rates.

Specifically, attack counts refer to the counts of malicious attacks on a data system or a network. These attacks include denial-of-service attacks, injection attacks, identity theft, etc. The attack counts are used for evaluating the security and robustness of the system. The error rates refer to a frequency at which errors occurs during data transmission or processing. Even without any malicious attack, the sent data may be erroneous during the data transmission. The error rates are used for measuring the reliability of the data transmission or a processing system. The repetition rates refer to a frequency at which repeated data occurs during the data transmission or processing. Occasionally, the same data is retransmitted or processed due to interference in communication, transmission errors, or other reasons. The repetition rates are used for measuring the accuracy of the data transmission or processing system. The miss rates refer to a frequency at which data is lost, due to transmission errors, communication disruption, system failure, etc., during the data transmission or processing. The miss rates are used for measuring the integrity of the data transmission or processing system. The channel blocking rates refer to a rate at which data cannot be transmitted due to channel blocking during the data transmission. Channel blocking refers to that, in data transmission, data cannot be transmitted through a channel due to insufficient channel capacity or other factors. The channel blocking rates are used for measuring the load and efficiency of a communication system.

The determination unit 30 is arranged for determining whether the substation monitoring terminal has a security risk according to the multiple trapezoid fuzzy sets.

Specifically, for example, nine fuzzy trapezoid fuzzy sets with uncertainty are determined according to the data quality, containing extremely low, very low, low, low, medium, high, high, very high, and extremely high, of parameters.

The control unit 40 is arranged for, in response to in the substation monitoring terminal having the security risk, controlling the traffic of the substation monitoring terminal to access the Internet of Things to be reduced.

In particular, reducing the traffic of the substation monitoring terminal to access the Internet of Things can help the substation detect and prevent potential security threats. In addition, abnormal data interaction patterns, abnormal data amounts or frequencies, etc. can be found through analyzing the traffic, thereby identifying possible attacks or illegal accesses. Early discovering security threats and adopting corresponding security measures can protect the security and integrity of the Internet of Things system.

By means of the present embodiment, the acquisition unit acquires the sent data of the substation monitoring terminal; the processing unit adopts the fuzzy inference method to process the sent data within the pre-determined time period to obtain the multiple trapezoid fuzzy sets, where the multiple trapezoid fuzzy sets are used for representing uncertainty of data quality parameters of the substation monitoring terminal, the multiple trapezoid fuzzy sets are obtained by sequencing according to the magnitude of the data quality parameters, the data quality parameters at least include: attack counts, error rates, repetition rates, miss rates and channel blocking rates; the determination unit determines whether the substation monitoring terminal has a security risk according to the multiple trapezoid fuzzy sets; the control unit reduces the traffic of the substation monitoring terminal to access the Internet of Things in response to in the substation monitoring terminal having the security risk. In this apparatus, a data error formed by attacks, errors, repetition, missing and channel blocking when the substation monitoring terminal sends data to the Internet of Things in combination with the fuzzy inference method, the trapezoid fuzzy sets can be calculated, so that a technical benefit evaluation index of the sent data sent from the substation monitoring terminal to the Internet of Things can be constructed to determine whether a substation monitoring terminal has a security risk; and in response to the substation monitoring terminal having the security risk, the traffic of the substation monitoring terminal to access the Internet of Things can be controlled to be reduced, thereby solving the problem of inaccurate security risk evaluation of the substation monitoring terminal.

In a specific implementation process, the multiple trapezoid fuzzy sets include: attack counts fuzzy sets, error rate fuzzy sets, repetition rate fuzzy sets, miss rate fuzzy sets and channel blocking rate fuzzy sets, where the attack counts fuzzy sets are trapezoid fuzzy sets corresponding to the attack counts, the error rate fuzzy sets are trapezoid fuzzy sets corresponding to the error rates, the repetition rate fuzzy sets are trapezoid fuzzy sets corresponding to the repetition rates, the miss rate fuzzy sets are trapezoid fuzzy sets corresponding to the miss rates, the channel blocking rate fuzzy sets are trapezoid fuzzy sets corresponding to the channel blocking rates. The processing unit includes a first calculation module, a second calculation module, a third calculation module, a fourth calculation module and a fifth calculation module. The first calculating module is arranged for, according to a formula N_{ADi}=(N_{ADi1}, N_{ADi2}, N_{ADi3}, N_{ADi4}; k_{DAi}), calculating an i^{th} attack counts fuzzy set N_{ADi}, where: N_{ADi1} is a first fuzzy coefficient of the i^{th} attack counts fuzzy set, N_{ADi2} is a second fuzzy coefficient of the i^{th} attack counts fuzzy set, N_{ADi3} is a third fuzzy coefficient of the i^{th} attack counts fuzzy set, N_{ADi4} is a fourth fuzzy coefficient of the i^{th} attack counts fuzzy set, and k_{DAi} is a membership coefficient of the i^{th} attack counts fuzzy set. The second calculating module is arranged for, according to a formula kₑᵢ=(kₑᵢ₁, kₑᵢ₂, kₑᵢ₃, kₑᵢ₄; kₑₖᵢ) calculating an i^{th} error rate fuzzy set kₑᵢ, where kₑᵢ₁ is a first fuzzy coefficient of the i^{th} error rate fuzzy set, kₑᵢ₂ is a second fuzzy coefficient of the i^{th} error rate fuzzy set, kₑᵢ₃ is a third fuzzy coefficient of the i^{th} error rate fuzzy set, kₑᵢ₄ is a fourth fuzzy coefficient of the i^{th} error rate fuzzy set, and kₑₖᵢ is a membership coefficient of the i^{th} error rate fuzzy set. The third calculating module is arranged for, according to a formula k_{Ri}=(k_{Ri1}, k_{Ri2}, k_{Ri3}, k_{Ri4}; k_{Rki}), calculating an i^{th} repetition rate fuzzy set k_{Ri}, where k_{Ri1} is a first fuzzy coefficient of the i^{th} repetition rate fuzzy set, k_{Ri2} is a second fuzzy coefficient of the i^{th} repetition rate fuzzy set, k_{Ri3} is a third fuzzy coefficient of the i^{th} repetition rate fuzzy set, k_{Ri4} is a fourth fuzzy coefficient of the i^{th} repetition rate fuzzy set, k_{Rki} is a membership coefficient of the i^{th} repetition rate fuzzy set. The fourth calculating module is arranged for, according to a formula k_{Li}=(k_{Li1}, k_{Li2}, k_{Li3}, k_{Li4}; k_{Lki}), calculating an i^{th} miss rate fuzzy set k_{Li}, where k_{Li1} is a first fuzzy coefficient of the i^{th} miss rate fuzzy set, k_{Li2} is a second fuzzy coefficient of the i^{th} miss rate fuzzy set, k_{Li3} is a third fuzzy coefficient of the i^{th} miss rate fuzzy set, k_{Li4} is a fourth fuzzy coefficient of the i^{th} miss rate fuzzy set, k_{Lki} is a membership coefficient of the i^{th} miss rate fuzzy set. The fifth calculating module is arranged for, according to a formula k_{Zi}=(k_{Zi1}, k_{Zi2}, k_{Zi3}, k_{Zi4}; k_{Zki}), calculating the i^{th} channel blocking rate fuzzy set k_{Zi}, where k_{Zi1} is a first fuzzy coefficient of the i^{th} channel blocking rate fuzzy set, k_{Zi2} is a second fuzzy coefficient of the i^{th} channel blocking rate fuzzy set, k_{Zi3} is a third fuzzy coefficient of the i^{th} channel blocking rate fuzzy set, k_{Zi4} is a fourth fuzzy coefficient of the i^{th} channel blocking rate fuzzy set, and k_{Zki} is a membership coefficient of the i^{th} channel blocking rate fuzzy set.

Specifically, each trapezoid fuzzy set is a form of common fuzzy set, and each trapezoid fuzzy set is composed of two straight lines with a rising slope and a falling slope, and two adjustable parameters. The trapezoid fuzzy set is used for describing some blurring phenomena, for example, the quality of some articles, the satisfaction degree of some people, and the like. Compared with other fuzzy set forms, the trapezoid fuzzy set has better interpretability and controllability, since the shape of this trapezoid fuzzy set is simple, parameters of this trapezoid fuzzy set are relatively intuitional for understanding and adjusting. In practical applications, the trapezoid fuzzy set is widely used for representing a fuzzy concept and a fuzzy rule, for example, the trapezoid fuzzy set is applied in fields such as a fuzzy control system and a fuzzy classifier.

In order to further quickly determine the security risk of data attacks of the substation monitoring terminal, the determination unit of the present disclosure includes a sixth calculation module, a first determination module and a second determination module. The sixth calculation module is arranged for, according to the multiple trapezoid fuzzy sets, calculating a falsity degree of the substation monitoring terminal and a security degree of the substation monitoring terminal, where the falsity degree is used for representing a falsity extent of the sent data, and the security degree is used for representing a security extent of the sent data. The first determination module is arranged for, in response to the falsity degree being greater than a first threshold value, determining that the substation monitoring terminal has a security risk of falsity data. The second determining module is arranged for, in response to the security degree being greater than a second threshold value, determining that the substation monitoring terminal has a security risk of a data attack.

Specifically, a value range of the first threshold is 0-0.1. A value range of the second threshold is 0-0.1. The value of the first threshold can be the same as the value of the second threshold, or the value of the first threshold can be different from the value of the second threshold.

The sixth calculation module includes a first calculation sub-module and a second calculation sub-module. The first calculation sub-module is arranged for, according to a formula:

$${k}_{F} = \frac{{N}_{FD}}{{N}_{TD} + {N}_{FD}} ,$$

calculating a falsity data amount N_{FD}, where N_{D} is a data amount of the sent data, t=1, 2, . . . , N_{RP}, k′_{eC} is a weight coefficient of data loss caused by data errors, k′_{eL} is a unit data loss value caused by the data errors, k_{eL} is the trapezoid fuzzy set corresponding to the error rates, k′_{RC} is a weight coefficient of data loss caused by data repetition, k′_{RL} is a unit data loss value caused by the data repetition, k_{Li} is the trapezoid fuzzy set corresponding to the repetition rates, k′_{LC} is a weight coefficient for data loss due to data missing, k′_{LL} is a unit data loss value caused by the data missing, k_{Li} is a trapezoid fuzzy set corresponding to the miss rates. The second calculation sub-module is arranged for acquiring a real data amount of the sent data, and according to a formula

$${k}_{F} = \frac{{N}_{FD}}{{N}_{TD} + {N}_{FD}} ,$$

calculating the falsity degree k_{F}, where N_{TD} is the real data amount of the sent data. The apparatus can further accurately calculate to obtain the falsity degree.

In particular, for example, k_{F}=0 represents data security; k_{F}>0, proves that there is falsity data, and the greater the value of k_{F}, the higher the degree of data risk. Data security level 1 warning is issued in response to 0<k_{F}≤0.1 Data security level 2 warning is issued in response to 0.2<k_{F}≤0.3. Data security level 3 warning is issued in response to 0.3<k_{F}≤0.4. Data security level 4 warning is issued in response to 0.4<k_{F}≤0.5. Data security level 5 warning is issued in response to 0.5<k_{F}≤0.6. Data security level 6 warning is issued in response to 0.6<k_{F}≤0.7. Data security level 7 warning is issued in response to 0.7<k_{F}≤0.8. Data security level 8 warning is issued in response to 0.8<k_{F}≤0.9. Data security level 9 warning is issued in response to 0.9<k_{F}≤1.0.

In some embodiments, the sixth calculation module includes a third calculation sub-module arranged for acquiring a real data amount of the sent data and a security data amount of the sent data, and according to a formula

$${k}_{A} = \frac{{N}_{AD}}{{N}_{TD} + {N}_{AD}} ,$$

calculating the security degree k_{A}, where N_{AD} is the security data amount of the sent data, and N_{TD} is the real data amount of the sent data. The apparatus may further calculate to obtain an accurate security degree.

In particular, for example, k_{A}=0 represents data security. k_{A}>0 proves that there is a data attack problem, and the larger the value of k_{A}, the higher the degree of data risk. Data security level 1 warning is issued in response to 0 k_{A}≤0.1. Data security level 2 warning is issued in response to 0.2<k_{A}≤0.3. Data security level 3 warning is issued in response to 0.3<k_{A}≤0.4. Data security level 4 warning is issued in response to 0.4<k_{A}≤0.5. Data security level 5 warning is issued in response to 0.5<k_{A}≤0.6. Data security level 6 warning is issued in response to 0.6<k_{A}≤0.7. Data security level 7 warning is issued in response to 0.7<k_{A}≤0.8. Data security level 8 warning is issued in response to 0.8<k_{A}≤0.9. Data security level 9 warning is issued in response to 0.9<k_{A}≤1.0.

In some embodiments, the determination unit includes a seventh calculation module and a third determination module. The seventh calculation module is arranged for, according to the multiple trapezoid fuzzy sets, calculating a trust degree of the substation monitoring terminal, where the trust degree is used for representing the risk extent of the substation monitoring terminal to access the Internet of Things. The third determination module is arranged for, in response to the trust degree being less than a third threshold value, determining that there is a security risk for the substation monitoring terminal accesses the Internet of Things. The apparatus can further rapidly determine, according to the trust degree, that there is the security risk when the substation monitoring terminal accesses the Internet of Things.

Specifically, a value range of the third threshold is 0.4-0.6.

In some embodiments, the seventh calculation module includes a fourth calculation sub-module, a fifth calculation sub-module and a sixth calculation sub-module. The fourth calculation sub-module is arranged for, according to a formula:

$${R}_{RP} = \frac{{n}_{G}}{{n}_{IoT}} \times E [ {⋁}_{i = 1}^{x} {k}_{Di} {v}_{Dvi} ⊗ {⋁}_{i = 1}^{x} {k}_{DSi} {S}_{Di} ⊗ {k}_{Mi} {M}_{G} ] ,$$

calculating a data gain value R_{RP} of the substation monitoring terminal, where the data gain value is used for representing a data gain obtained by the substation monitoring terminal through data acquisition, data transmission, data storage and data sharing, n_{G} is the number of users using the substation monitoring terminal to access the Internet of Things, n_{IoT} is the number of users of the Internet of Things,

$${⋁}_{i = 1}^{x} {k}_{Di} {v}_{Dvi}$$

is an information gain value obtained by providing the data transmission with X fuzzy uncertainty rates to the substation monitoring terminal,

$${⋁}_{i = 1}^{x} {k}_{DSi} {S}_{Di}$$

is an information gain value obtained by providing the data storage and the data sharing with X fuzzy uncertainty scales to the substation monitoring terminal, k_{Mi}M_{G} is an information gain value obtained through providing, by the Internet of Things at a sensing layer, the collecting data to the substation monitoring terminal. The fifth calculation sub-module is arranged for, according to a formula:

$${L}_{D} = {\sum }_{t = 1}^{{N}_{RP}} ( {k}_{AC}^{t} {k}_{AL}^{t} {\sum }_{i = 1}^{x} E [ {N}_{ADi} ] + {k}_{eC}^{t} {k}_{eL}^{t} {\sum }_{i = 1}^{x} E [ {k}_{ei} ] ) + {\sum }_{t = 1}^{{N}_{RP}} ( {k}_{RC}^{t} {k}_{RL}^{t} {\sum }_{i = 1}^{x} E [ {k}_{Ri} ] + {k}_{LC}^{t} {k}_{LL}^{t} {\sum }_{i = 1}^{x} E [ {k}_{Li} ] ) + {\sum }_{t = 1}^{{N}_{RP}} ( {k}_{ZC}^{t} {k}_{ZL}^{t} {\sum }_{i = 1}^{x} E [ {k}_{Zi} ] ) ,$$

calculating a data loss value L_{D} of the substation monitoring terminal, where the data loss value is used for representing data loss caused by data attack, data error, data repetition, data missing and channel blocking, t=1, 2, . . . , N_{RP}, k′_{AC} is a weight coefficient of the data loss caused by the data attack, k′_{AL} is a unit data loss value caused by the data attack, N_{ADi} is a trapezoid fuzzy set corresponding to the attack counts, k′_{eC} is a weight coefficient of data loss caused by the data error, k′_{eL} is a unit data loss value caused by the data error, kₑᵢ is a trapezoid fuzzy set corresponding to the error rate, and k′_{RC} is a weight coefficient of data loss caused by the data repetition, k′_{RL} is a unit data loss value caused by the data repetition, k_{Ri} is a trapezoid fuzzy set corresponding to the repetition rates, k′_{LC} is a weight coefficient for data loss due to the data missing, k′_{LL} is a unit data loss value caused by the data missing, k_{Li} is a trapezoid fuzzy set corresponding to the miss rates, k′_{ZC} is a weight coefficient of data loss caused by the channel blocking, k′_{ZL} is a unit data loss value caused by the channel blocking, k_{Zi} is a trapezoid fuzzy set corresponding to the channel blocking rates. The sixth calculating sub-module is arranged for calculating the trust degree B₁ according to a formula

$${B}_{1} = \frac{{R}_{RP}}{{R}_{RP} + {L}_{D}} .$$

The apparatus can further calculate to obtain an accurate credibility.

Specifically, for example, when 0.5≤B₁<1, the substation monitoring terminal is allowed to access the Internet of Things with full data traffic, and when 0.3≤B₁<0.5, user access traffic is controlled to be B₁ times standard traffic, the user is allowed to access the Internet of Things moderately. When 0≤B₁<0.3 an access traffic of the substation monitoring terminal is restricted to be 0, thereby preventing the user from accessing the Internet of Things, and not allowing the substation monitoring terminal to access the Internet of Things.

The above-mentioned apparatus for controlling the substation monitoring terminal includes a processor and a memory. The acquisition unit, the processing unit, the determination unit and the control unit, and the like are all stored in the memory as program units. And the processor executes the program units stored in the memory to implement corresponding functions. The modules are all located in the same processor; or the modules are located in different processors in any combination form.

The processor includes a kernel, and the kernel removes a corresponding program unit from the memory. The kernel may set at least one, and security protection of the power Internet of Things is improved by adjusting kernel parameters.

The memory includes a non-persistent memory, a random access memory (RAM), and/or a non-transitory memory in a computer-readable medium, for example, a read-only memory (ROM) or a flash RAM, and the memory includes at least one storage chip.

In some embodiments of the present disclosure, a non-transitory storage medium is further provided, where the non-transitory storage medium includes a program, and when the program runs, a device where the non-transitory storage medium is located is controlled to execute the method for controlling the substation monitoring terminal.

Specifically, the method for controlling a substation monitoring terminal includes the following steps.

In step S201, sent data of the substation monitoring terminal is acquired, where the sent data is data sent from the substation monitoring terminal to the Internet of Things, and the data at least includes electricity consumption data of an electricity consumption device monitored by the substation monitoring terminal.

Specifically, the sent data includes: a high-low voltage side voltage, a current, a power, a frequency, a temperature, a pressure and a humidity of a transformer; a voltage, a current, a power of a bus bar; a voltage, a current, a power of inlet and outlet; an operating state of a switch; a running state, a voltage, a current and a power of an energy storage system; a running state, a voltage, a current and a power of a charging post; a running state, a voltage, a current and a power of a reactive power compensator.

In step S202, a fuzzy inference method is adopted to process the sent data within a pre-determined time period to obtain multiple trapezoid fuzzy sets, where the multiple trapezoid fuzzy sets are used for representing uncertainty of data quality parameters of the substation monitoring terminal, the multiple trapezoid fuzzy sets are obtained by sequencing according to the magnitude of the data quality parameters, the data quality parameters at least include: attack counts, error rates, repetition rates, miss rates and channel blocking rates.

Specifically, attack counts refer to the counts of malicious attacks on a data system or a network. These attacks include denial-of-service attacks, injection attacks, identity theft, etc. The attack counts are used for evaluating the security and robustness of the system. The error rates refer to a frequency at which errors occurs during data transmission or processing. Even without any malicious attack, the sent data may be erroneous during the data transmission. The error rates are used for measuring the reliability of the data transmission or a processing system. The repetition rates refer to a frequency at which repeated data occurs during the data transmission or processing. Occasionally, the same data is retransmitted or processed due to interference in communication, transmission errors, or other reasons. The repetition rates are used for measuring the accuracy of the data transmission or processing system. The miss rates refer to a frequency at which data is lost, due to transmission errors, communication disruption, system failure, etc., during the data transmission or processing. The miss rates are used for measuring the integrity of the data transmission or processing system. The channel blocking rates refer to a rate at which data cannot be transmitted due to channel blocking during the data transmission. Channel blocking refers to that, in data transmission, data cannot be transmitted through a channel due to insufficient channel capacity or other factors. The channel blocking rates are used for measuring the load and efficiency of a communication system.

In step S203, it is determined whether the substation monitoring terminal has a security risk according to the multiple trapezoid fuzzy sets.

Specifically, for example, nine fuzzy trapezoid fuzzy sets with uncertainty are determined according to the data quality, containing extremely low, very low, low, low, medium, high, high, very high, and extremely high, of parameters.

In step S204, in response to in the substation monitoring terminal having the security risk, the traffic of the substation monitoring terminal to access the Internet of Things is controlled to be reduced.

In particular, reducing the traffic of the substation monitoring terminal to access the Internet of Things can help the substation detect and prevent potential security threats. In addition, abnormal data interaction patterns, abnormal data amounts or frequencies, etc. can be found through analyzing the traffic, thereby identifying possible attacks or illegal accesses. Early discovering security threats and adopting corresponding security measures can protect the security and integrity of the Internet of Things system.

In some embodiments, a processor is further provided. The processor is arranged for running a program. The processor is controlled to execute the method for controlling the substation monitoring terminal when the program runs.

Specifically, the method for controlling a substation monitoring terminal includes the following steps.

In step S201, sent data of the substation monitoring terminal is acquired, where the sent data is data sent from the substation monitoring terminal to the Internet of Things, and the data at least includes electricity consumption data of an electricity consumption device monitored by the substation monitoring terminal.

In step S202, a fuzzy inference method is adopted to process the sent data within a pre-determined time period to obtain multiple trapezoid fuzzy sets, where the multiple trapezoid fuzzy sets are used for representing uncertainty of data quality parameters of the substation monitoring terminal, the multiple trapezoid fuzzy sets are obtained by sequencing according to the magnitude of the data quality parameters, the data quality parameters at least include: attack counts, error rates, repetition rates, miss rates and channel blocking rates.

In step S203, it is determined whether the substation monitoring terminal has a security risk according to the multiple trapezoid fuzzy sets.

In step S204, in response to in the substation monitoring terminal having the security risk, the traffic of the substation monitoring terminal to access the Internet of Things is controlled to be reduced.

In some embodiments, a device is further provided. The device includes a processor, a memory and a program stored in the memory and capable of running on the processor. When the processor executes the program, at least the following steps are implemented.

In step S201, sent data of the substation monitoring terminal is acquired, where the sent data is data sent from the substation monitoring terminal to the Internet of Things, and the data at least includes electricity consumption data of an electricity consumption device monitored by the substation monitoring terminal.

In step S202, a fuzzy inference method is adopted to process the sent data within a pre-determined time period to obtain multiple trapezoid fuzzy sets, where the multiple trapezoid fuzzy sets are used for representing uncertainty of data quality parameters of the substation monitoring terminal, the multiple trapezoid fuzzy sets are obtained by sequencing according to the magnitude of the data quality parameters, the data quality parameters at least include: attack counts, error rates, repetition rates, miss rates and channel blocking rates.

In step S203, it is determined whether the substation monitoring terminal has a security risk according to the multiple trapezoid fuzzy sets.

In step S204, in response to in the substation monitoring terminal having the security risk, the traffic of the substation monitoring terminal to access the Internet of Things is controlled to be reduced.

The device herein may be a server, a PC, a PAD, a mobile phone, etc.

In some embodiments of the present disclosure, a computer program product is further provided, and when executed on a data processing device, computer program product is adapted to execute a program initialized with at least the following method steps.

In step S201, sent data of the substation monitoring terminal is acquired, where the sent data is data sent from the substation monitoring terminal to the Internet of Things, and the data at least includes electricity consumption data of an electricity consumption device monitored by the substation monitoring terminal.

In step S202, a fuzzy inference method is adopted to process the sent data within a pre-determined time period to obtain multiple trapezoid fuzzy sets, where the multiple trapezoid fuzzy sets are used for representing uncertainty of data quality parameters of the substation monitoring terminal, the multiple trapezoid fuzzy sets are obtained by sequencing according to the magnitude of the data quality parameters, the data quality parameters at least include: attack counts, error rates, repetition rates, miss rates and channel blocking rates.

In step S203, it is determined whether the substation monitoring terminal has a security risk according to the multiple trapezoid fuzzy sets.

In step S204, in response to in the substation monitoring terminal having the security risk, the traffic of the substation monitoring terminal to access the Internet of Things is controlled to be reduced.

It should be apparent to those skilled in the art that the various modules or steps of the present disclosure can be implemented by a general-purpose computing device, and the various modules or steps can be concentrated on a single computing device or distributed on a network composed of multiple computing devices, and the various modules or steps can be stored in a storage device for execution by the computing device, and in some cases, the steps shown or described can be performed in an order different from that described herein, or can be fabricated into individual integrated circuit modules, or multiple modules or steps in the integrated circuit modules can be fabricated into a single integrated circuit module. In this way, the present disclosure is not limited to any specific combination of hardware and software.

Those skilled in the art should understand that the embodiments of present disclosure can be provided as a method, a system, or a computer program product. Therefore, the present disclosure may use a form of hardware embodiments, software embodiments, or embodiments with a combination of software and hardware. Moreover, the present disclosure may use a form of a computer program product implemented on at least one computer-usable storage media (including but not limited to a disk memory, a CD-ROM, an optical memory, and the like) including computer-usable program codes.

The present disclosure is described with reference to the flowcharts and/or block diagrams of the method, the device (system), and the computer program product according to the embodiments of present disclosure. It should be understood that computer program instructions can be used for implementing each process and/or block in the flowcharts and/or the block diagrams and a combination of a process and/or a block in the flowcharts and/or the block diagrams. These computer program instructions can be provided to a general-purpose computer, a special-purpose computer, an embedded processor, or a processor of another programmable data processing device to generate a machine, so that the instructions executed by the processor of the computer or other programmable data processing devices generate an apparatus for implementing the functions specified in at least one flow of the flowcharts and/or at least one block in the block diagrams.

These computer program instructions may also be stored in a computer-readable memory capable of guiding a computer or other programmable data processing devices to operate in a specific manner, so that the instructions stored in the computer-readable memory produce an article of manufacture including an instruction apparatus that implements the functions specified in at least one flow of the flowchart and/or at least one block of the block diagram.

These computer program instructions may also be loaded onto a computer or other programmable data processing device such that a series of operational steps are performed on the computer or other programmable device to produce a computer-implemented process, such that the instructions executed on the computer or other programmable device provide steps for implementing the functions specified in at least one flow of the flowchart and/or at least one block of the block diagram.

In one typical configuration, a computing device includes at least one processor (such as CPU), input/output interface, network interface, and memory.

The memory may include a non-persistent memory, a random access memory (RAM), and/or a non-transitory memory in a computer-readable medium, for example, a read-only memory (ROM) or a flash RAM. The memory is an example of a computer-readable medium.

The computer-readable medium includes persistent, non-persistent, movable, and non-removable media that can store information by using any method or technology. The information can be a computer-readable instruction, a data structure, a program module, or other data. Examples of computer storage media include, but are not limited to, phase-change random access memory (PRAM), static random access memory (SRAM), dynamic random access memory (DRAM), other types of random access memory (RAM), read only memory (ROM), electrically erasable programmable read only memory (EEPROM), flash memory or other memory technology, read only optical disk read only memory (CD-ROM), digital versatile disk (DVD), or other optical storage, magnetic cassettes, magnetic tape, magnetic disk storage or other magnetic storage devices, or any other non-transmission medium, can be used for storing information that can be accessed by a computing device. As defined herein, the computer-readable medium does not include transitory media, such as a modulated data signal and a carrier.

It should also be noted that the terms “comprising”, “including” or any other variation thereof are intended to cover a non-exclusive inclusion, so that a process, method, commodity, or device that includes a series of elements includes not only those elements, but also other elements that are not explicitly listed, or elements inherent to such a process, method, commodity, or device. In the absence of more restrictions, the statement” includes one. There are no additional identical elements in the process, method, product, or device that includes the element.

From the above description, it can be seen that the above embodiments of the present disclosure achieve the following technical effects.

In the method for controlling the substation monitoring terminal, sent data of the substation monitoring terminal is acquired; a fuzzy inference method is adopted to process the sent data within a pre-determined time period to obtain multiple trapezoid fuzzy sets; it is determined whether the substation monitoring terminal has a security risk according to the multiple trapezoid fuzzy sets; in response to in the substation monitoring terminal having the security risk, the traffic of the substation monitoring terminal to access the Internet of Things is controlled to be reduced. In this method, a data error formed by attacks, errors, repetition, missing and channel blocking when the substation monitoring terminal sends data to the Internet of Things in combination with the fuzzy inference method, the trapezoid fuzzy sets can be calculated, so that a technical benefit evaluation index of the sent data sent from the substation monitoring terminal to the Internet of Things can be constructed to determine whether a substation monitoring terminal has a security risk; and in response to the substation monitoring terminal having the security risk, the traffic of the substation monitoring terminal to access the Internet of Things can be controlled to be reduced, thereby solving the problem of inaccurate security risk evaluation of the substation monitoring terminal.

In the apparatus for controlling the substation monitoring terminal, sent data of the substation monitoring terminal is acquired; a fuzzy inference method is adopted to process the sent data within a pre-determined time period to obtain multiple trapezoid fuzzy sets; it is determined whether the substation monitoring terminal has a security risk according to the multiple trapezoid fuzzy sets; in response to in the substation monitoring terminal having the security risk, the traffic of the substation monitoring terminal to access the Internet of Things is controlled to be reduced. In this method, a data error formed by attacks, errors, repetition, missing and channel blocking when the substation monitoring terminal sends data to the Internet of Things in combination with the fuzzy inference method, the trapezoid fuzzy sets can be calculated, so that a technical benefit evaluation index of the sent data sent from the substation monitoring terminal to the Internet of Things can be constructed to determine whether a substation monitoring terminal has a security risk; and in response to the substation monitoring terminal having the security risk, the traffic of the substation monitoring terminal to access the Internet of Things can be controlled to be reduced, thereby solving the problem of inaccurate security risk evaluation of the substation monitoring terminal.

The descriptions are exemplary embodiments of present disclosure and are not intended to limit present disclosure, and for those skilled in the art, the present disclosure may have various changes and changes. Any modification, equivalent replacement, or improvement made within the spirit and principle of present disclosure shall fall within the protection scope of present disclosure.

What is claimed is:

1. A method for controlling a substation monitoring terminal, comprising:
acquiring sent data of the substation monitoring terminal, wherein the sent data is data sent from the substation monitoring terminal to the Internet of Things, and the data at least comprises electricity consumption data of an electricity consumption device monitored by the substation monitoring terminal;
adopting a fuzzy inference method to process the sent data within a pre-determined time period to obtain a plurality of trapezoid fuzzy sets, wherein the plurality of trapezoid fuzzy sets are used for representing uncertainty of data quality parameters of the substation monitoring terminal, the plurality of trapezoid fuzzy sets are obtained by sequencing according to the magnitude of the data quality parameters, the data quality parameters at least comprise: attack counts, error rates, repetition rates, miss rates and channel blocking rates;
determining whether the substation monitoring terminal has a security risk according to the plurality of trapezoid fuzzy sets; and
in response to in the substation monitoring terminal having the security risk, controlling the traffic of the substation monitoring terminal to access the Internet of Things to be reduced.

2. The method as claimed in claim 1, wherein the plurality of trapezoid fuzzy sets comprise: attack counts fuzzy sets, error rate fuzzy sets, repetition rate fuzzy sets, miss rate fuzzy sets and channel blocking rate fuzzy sets, wherein the attack counts fuzzy sets are trapezoid fuzzy sets corresponding to the attack counts, the error rate fuzzy sets are trapezoid fuzzy sets corresponding to the error rates, the repetition rate fuzzy sets are trapezoid fuzzy sets corresponding to the repetition rates, the miss rate fuzzy sets are trapezoid fuzzy sets corresponding to the miss rates, the channel blocking rate fuzzy sets are trapezoid fuzzy sets corresponding to the channel blocking rates, and adopting the fuzzy inference method to process the sent data within the pre-determined time period to obtain the plurality of trapezoid fuzzy sets comprising:
according to a formula N_{ADi}=(N_{ADi1}, N_{ADi2}, N_{ADi3}, N_{ADi4}; k_{DAi}), calculating an i^{th} attack counts fuzzy set N_{ADi}, wherein N_{ADi1} is a first fuzzy coefficient of the i^{th} attack counts fuzzy set, N_{ADi2} is a second fuzzy coefficient of the i^{th} attack counts fuzzy set, N_{ADi3} is a third fuzzy coefficient of the i^{th} attack counts fuzzy set, N_{ADi4} is a fourth fuzzy coefficient of the i^{th} attack counts fuzzy set, and k_{DAi} is a membership coefficient of the i^{th} attack counts fuzzy set;
according to a formula kₑᵢ=(kₑᵢ₁, kₑᵢ₂, kₑᵢ₃, kₑᵢ₄; kₑₖᵢ), calculating an i^{th} error rate fuzzy set kₑᵢ, wherein kₑᵢ₁ is a first fuzzy coefficient of the i^{th} error rate fuzzy set, kₑᵢ₂ is a second fuzzy coefficient of the i^{th} error rate fuzzy set, kₑᵢ₃ is a third fuzzy coefficient of the i^{th} error rate fuzzy set, kₑᵢ₄ is a fourth fuzzy coefficient of the i^{th} error rate fuzzy set, and kₑₖᵢ is a membership coefficient of the i^{th} error rate fuzzy set;
according to a formula k_{Ri}=(k_{Ri1}, k_{Ri2}, k_{Ri3}, k_{Ri4}; k_{Rki}), calculating an i^{th} repetition rate fuzzy set k_{Ri}, wherein k_{Ri1} is a first fuzzy coefficient of the i^{th} repetition rate fuzzy set, k_{Ri2} is a second fuzzy coefficient of the i^{th} repetition rate fuzzy set, k_{Ri3} is a third fuzzy coefficient of the i^{th} repetition rate fuzzy set, R_{Ri4} is a fourth fuzzy coefficient of the i^{th} repetition rate fuzzy set, k_{Rki} is a membership coefficient of the i^{th} repetition rate fuzzy set;
according to a formula k_{Li}=(k_{Li1}, k_{Li2}, k_{Li3}, k_{Li4}; k_{Lki}), calculating an i^{th} miss rate fuzzy set k_{Li}, wherein k_{Li1} is a first fuzzy coefficient of the i^{th} miss rate fuzzy set, k_{Li2} is a second fuzzy coefficient of the i^{th} miss rate fuzzy set, k_{Li3} is a third fuzzy coefficient of the i^{th} miss rate fuzzy set, k_{Li4} is a fourth fuzzy coefficient of the i^{th} miss rate fuzzy set, k_{Lki} is a membership coefficient of the i^{th} miss rate fuzzy set; and
according to a formula k_{Zi}=(k_{Zi1}, k_{Zi2}, k_{Zi3}, k_{Zi4}; k_{Zki}), calculating the i^{th} channel blocking rate fuzzy set k_{Zi}, wherein k_{Zi1} is a first fuzzy coefficient of the i^{th} channel blocking rate fuzzy set, k_{Zi2} is a second fuzzy coefficient of the i^{th} channel blocking rate fuzzy set, k_{Zi3} is a third fuzzy coefficient of the i^{th} channel blocking rate fuzzy set, k_{Zi4} is a fourth fuzzy coefficient of the i^{th} channel blocking rate fuzzy set, and k_{Zki} is a membership coefficient of the i^{th} channel blocking rate fuzzy set.

3. The method as claimed in claim 1, wherein determining whether the substation monitoring terminal has the security risk according to the plurality of trapezoid fuzzy sets comprises:
according to the plurality of trapezoid fuzzy sets, calculating a falsity degree of the substation monitoring terminal and a security degree of the substation monitoring terminal, wherein the falsity degree is used for representing a falsity extent of the sent data, and the security degree is used for representing a security extent of the sent data;
in response to the falsity degree being greater than a first threshold value, determining that the substation monitoring terminal has a security risk of falsity data; and
in response to the security degree being greater than a second threshold value, determining that the substation monitoring terminal has a security risk of a data attack.

4. The method as claimed in claim 3, wherein calculating the falsity degree of the substation monitoring terminal according to the plurality of trapezoid fuzzy sets comprises:
according to a formula:
$${N}_{FD} = {N}_{D} {\sum }_{t = 1}^{{N}_{RP}} ( {k}_{eC}^{t} {k}_{eL}^{t} {\sum }_{i = 1}^{x} E [ {k}_{ei} ] + {k}_{RC}^{t} {k}_{RL}^{t} {\sum }_{i = 1}^{x} E [ {k}_{Ri} ] + {k}_{LC}^{t} {k}_{LL}^{t} {\sum }_{i = 1}^{x} E [ {k}_{Li} ] ) ,$$
calculating a falsity data amount N_{FD}, wherein N_{D} is a data amount of the sent data, t=1, 2, . . . , N_{RP}, k′_{eC} is a weight coefficient of data loss caused by data errors, k′_{eL} is a unit data loss value caused by the data errors, kₑᵢ is the trapezoid fuzzy set corresponding to the error rates, k′_{RC} is a weight coefficient of data loss caused by data repetition, k′_{RL} is a unit data loss value caused by the data repetition, k_{Ri} is the trapezoid fuzzy set corresponding to the repetition rates, k′_{LC} is a weight coefficient for data loss due to data missing, k′_{LL} is a unit data loss value caused by the data missing, k_{Li} is a trapezoid fuzzy set corresponding to the miss rates; and
acquiring a real data amount of the sent data, and according to a formula
$${k}_{P} = \frac{{N}_{FD}}{{N}_{TD} + {N}_{FD}} ,$$
calculating the falsity degree k_{F}, wherein N_{ID} is the real data amount of the sent data.

5. The method as claimed in claim 3, wherein calculating the security degree of the substation monitoring terminal according to the plurality of trapezoid fuzzy sets comprises:
acquiring a real data amount of the sent data and a security data amount of the sent data, and according to a formula:
$${k}_{A} = \frac{{N}_{AD}}{{N}_{TD} + {N}_{AD}} .$$
calculating the security degree k_{A}, wherein N_{AD} is the security data amount of the sent data, and N_{TD} is the real data amount of the sent data.

6. The method as claimed in claim 1, wherein determining whether the substation monitoring terminal has the security risk according to the plurality of trapezoid fuzzy sets comprises:
according to the plurality of trapezoid fuzzy sets, calculating a trust degree of the substation monitoring terminal, wherein the trust degree is used for representing the risk extent of the substation monitoring terminal to access the Internet of Things; and
in response to the trust degree being less than a third threshold value, determining that there is a security risk for the substation monitoring terminal accesses the Internet of Things.

7. The method as claimed in claim 6, wherein calculating the trust degree of the substation monitoring terminal according to the trapezoid fuzzy sets comprises:
according to a formula
$${R}_{RP} = \frac{{n}_{G}}{{n}_{IoT}} \times E [ {⋁}_{i = 1}^{x} {k}_{Di} {v}_{Dvi} ⊗ {⋁}_{i = 1}^{x} {k}_{DSi} {S}_{Di} ⊗ {k}_{Mi} {M}_{G} ] ,$$
calculating a data gain value R_{RP} of the substation monitoring terminal, wherein the data gain value is used for representing a data gain obtained by the substation monitoring terminal through data acquisition, data transmission, data storage and data sharing, n_{G} is the number of users using the substation monitoring terminal to access the Internet of Things, n_{IoT} is the number of users of the Internet of Things,
$${⋁}_{i = 1}^{x} {k}_{Di} {v}_{Dvi}$$
is an information gain value obtained by providing the data transmission with X fuzzy uncertainty rates to the substation monitoring terminal,
$${⋁}_{i = 1}^{x} {k}_{DSi} {S}_{Di}$$
is an information gain value obtained by providing the data storage and the data sharing with x fuzzy uncertainty scales to the substation monitoring terminal, k_{Mi}M_{G} is an information gain value obtained through providing, by the Internet of Things at a sensing layer, the collecting data to the substation monitoring terminal;
according to a formula:
$${L}_{D} = {\sum }_{t = 1}^{{N}_{RP}} ( {k}_{AC}^{t} {k}_{AL}^{t} {\sum }_{i = 1}^{x} E [ {N}_{ADi} ] + {k}_{eC}^{t} {k}_{eL}^{t} {\sum }_{i = 1}^{x} E [ {k}_{ei} ] ) + {\sum }_{t = 1}^{{N}_{RP}} ( {k}_{RC}^{t} {k}_{RL}^{t} {\sum }_{i = 1}^{x} E [ {k}_{Ri} ] + {k}_{LC}^{t} {k}_{LL}^{t} {\sum }_{i = 1}^{x} E [ {k}_{Li} ] ) + {\sum }_{t = 1}^{{N}_{RP}} ( {k}_{ZC}^{t} {k}_{ZL}^{t} {\sum }_{i = 1}^{x} E [ {k}_{Zi} ] ) ,$$
calculating a data loss value L_{D} of the substation monitoring terminal, wherein the data loss value is used for representing data loss caused by data attack, data error, data repetition, data missing and channel blocking, t=1, 2, . . . , N_{RP}, k′_{AC} is a weight coefficient of the data loss caused by the data attack, k′_{AL} is a unit data loss value caused by the data attack, N_{ADi} is a trapezoid fuzzy set corresponding to the attack counts, k′_{eC} is a weight coefficient of data loss caused by the data error, k′_{eL} is a unit data loss value caused by the data error, kₑᵢ is a trapezoid fuzzy set corresponding to the error rate, and k′_{LC} is a weight coefficient of data loss caused by the data repetition, k′_{LL} is a unit data loss value caused by the data repetition, k_{Li} is a trapezoid fuzzy set corresponding to the repetition rates, k′_{LC} is a weight coefficient for data loss due to the data missing, k′_{LL} is a unit data loss value caused by the data missing, k_{Li} is a trapezoid fuzzy set corresponding to the miss rates, k′_{ZC} is a weight coefficient of data loss caused by the channel blocking, k′_{ZL} is a unit data loss value caused by the channel blocking, k_{Zi} is a trapezoid fuzzy set corresponding to the channel blocking rates; and
calculating the trust degree B₁ according to a formula
$${B}_{1} = \frac{{R}_{RP}}{{R}_{RP} + {L}_{D}} .$$

8. The method as claimed in claim 1, wherein the attack counts refer to the counts of malicious attacks on a data system or a network.

9. The method as claimed in claim 8, wherein the attack counts are used for evaluating the security and robustness of the data system or the network.

10. The method as claimed in claim 1, wherein the error rates refer to a frequency at which errors occurs during data transmission or processing.

11. The method as claimed in claim 10, wherein the error rates are used for measuring the reliability of the data transmission or processing.

12. The method as claimed in claim 1, wherein the repetition rates refer to a frequency at which repeated data occurs during data transmission or processing.

13. The method as claimed in claim 12, wherein the repetition rates are used for measuring the accuracy of the data transmission or processing.

14. The method as claimed in claim 1, wherein the miss rates refer to a frequency at which data is lost during data transmission or processing.

15. The method as claimed in claim 14, wherein the miss rates are used for measuring the integrity of the data transmission or processing.

16. The method as claimed in claim 1, wherein the channel blocking rates refer to a rate at which data cannot be transmitted due to channel blocking during data transmission.

17. The method as claimed in claim 16, wherein the channel blocking rates are used for measuring the load and efficiency of the data transmission.

18. A non-transitory storage medium, wherein the non-transitory storage medium comprises a program, wherein when the program runs, a device where the non-transitory storage medium is located is controlled to execute:
acquiring sent data of the substation monitoring terminal, wherein the sent data is data sent from the substation monitoring terminal to the Internet of Things, and the data at least comprises electricity consumption data of an electricity consumption device monitored by the substation monitoring terminal;
adopting a fuzzy inference method to process the sent data within a pre-determined time period to obtain a plurality of trapezoid fuzzy sets, wherein the plurality of trapezoid fuzzy sets are used for representing uncertainty of data quality parameters of the substation monitoring terminal, the plurality of trapezoid fuzzy sets are obtained by sequencing according to the magnitude of the data quality parameters, the data quality parameters at least comprise: attack counts, error rates, repetition rates, miss rates and channel blocking rates;
determining whether the substation monitoring terminal has a security risk according to the plurality of trapezoid fuzzy sets; and
in response to in the substation monitoring terminal having the security risk, controlling the traffic of the substation monitoring terminal to access the Internet of Things to be reduced.

19. An electronic apparatus, comprising a memory and a processor, wherein the memory is arranged for storing a computer program, and the processor is arranged for executing, according to the computer program, the following:
acquiring sent data of the substation monitoring terminal, wherein the sent data is data sent from the substation monitoring terminal to the Internet of Things, and the data at least comprises electricity consumption data of an electricity consumption device monitored by the substation monitoring terminal;
adopting a fuzzy inference method to process the sent data within a pre-determined time period to obtain a plurality of trapezoid fuzzy sets, wherein the plurality of trapezoid fuzzy sets are used for representing uncertainty of data quality parameters of the substation monitoring terminal, the plurality of trapezoid fuzzy sets are obtained by sequencing according to the magnitude of the data quality parameters, the data quality parameters at least comprise: attack counts, error rates, repetition rates, miss rates and channel blocking rates;
determining whether the substation monitoring terminal has a security risk according to the plurality of trapezoid fuzzy sets; and
in response to in the substation monitoring terminal having the security risk, controlling the traffic of the substation monitoring terminal to access the Internet of Things to be reduced.
